(19) United States
(12) Patent Application Publication
(10) Pub. No.: US 2026/0208715 A1
(43) Pub. Date: Jul. 23, 2026

(54) ELECTRO-HYDRAULIC ACTUATOR FOR A BRAKE

(71) Applicant: Brembo S.p.A., Curno, Bergamo (IT)

(72) Inventors: Marco CARRARA, Curno, Bergamo (IT); Luca MAZZEI, Curno, Bergamo (IT); Paolo SALA, Curno, Bergamo (IT)

(21) Appl. No.: 19/141,099

(22) PCT Filed: Dec. 21, 2023
(86) PCT No.: PCT/IB2023/063084

§ 371 Date: Jun. 19, 2025

(30) Foreign Application Priority Data
Dec. 23, 2022 (IT) 102022000026673

(51) Int. Cl. B60T 13/74

(52) U.S. Cl. CPC B60T 13/745

(57) ABSTRACT

The present invention relates to an electro-hydraulic actuator (100) for actuating a brake caliper, in particular of a disc brake of a vehicle with two or more wheels, comprising:-an electric motor (1) with a drive shaft (2);—a transformation mechanism (3) connected to the drive shaft (2) to transform a rotary motion of the drive shaft (2) into a linear translatory motion along an axial direction (X-X) of a float (4) of a hydraulic pump or brake master cylinder of said brake to pressurize a brake fluid;—a first housing (5) configured to accommodate the transformation mechanism (3) and support a second housing (6) of the electric motor (1), said transformation mechanism (3) including:—a reduction unit (7) with at least one output interface (8) and configured to demultiply the rotary motion of the drive shaft (2) and transmit it to at least one output interface (8),—a transformation unit (10) to convert the rotary motion of the at least one output interface (8) into a translatory motion of the float (4), the transformation unit (10) comprising a rotating member (11), which is connected to the at least one output interface (8), and a thrust member (12), which is linearly translatable, wherein the rotating member (11) is mechanically coupled to the thrust member (12) so to transform a rotation of the rotating member (11) into a linear translation of the thrust member (12) which allows a displacement in the axial direction (X-X) of the float (4),-a bearing (9) connected to both the rotating member (11) and the first housing (5) to allow the rotation of the rotating member (11) with respect to the first housing (5), wherein the bearing (9) is packed between a first-housing shoulder (15) and said reduction unit (7) by constraining the bearing (9) in first housing (5), so that a constraining reaction of the transformation unit (10) due to the action of the float (4) on the brake fluid is discharged directly onto the reduction unit (7).

### FIELD OF THE INVENTION

The present invention relates to an electro-hydraulic actuator for a brake, as well as to a braking system for a vehicle, preferably of the brake by wire type.

### BACKGROUND ART

Braking systems of the BBW (“Brake By Wire”) type for cars are known and widespread, in which a linear transducer connected to a brake pedal is configured to detect the travel of the brake pedal and transmit an electric signal, indicative of the request for braking torque by the user, to a control unit. Such a control unit processes the signal of the transducer and controls an electric motor of a hydraulic pump as a function of the required braking torque. The hydraulic pump operated by the electric motor pressurizes and conveys a hydraulic fluid to the hydraulic pressure units of the vehicle brakes.

Compared to traditional braking systems, in which the brake pedal acts directly on the hydraulic circuit, the advantage of the “Brake By Wire” systems is the ability to generate and control the hydraulic pressure of the braking system without the aid of the force applied by the brake pedal. Moreover, the at least partial replacement of hydraulic circuits by electric circuits allows a saving in hydraulic fluid, a reduction in weight, and a reduction in the environmental impact of the whole braking system.

Solutions of electro-hydraulic actuators for a hydraulic brake are known, comprising an electric motor with a drive shaft and a transformation mechanism connected to the drive shaft for transforming a rotary motion of the drive shaft into a translatory motion of a translatable portion configured to act on the hydraulic pump.

The transformation mechanism comprises a mechanically coupled rotating member and a thrust member adapted to linearly translate with a rotation of the rotating member. In solutions of the known type, the rotating member is connected to a bearing so as to rotate with respect to a housing of the linear actuator, receiving the rotary motion of the drive shaft. The bearing is usually connected to a reduction gear, which allows demultiplying the rotary motion of the drive shaft and transmitting the demultiplied rotary motion of the drive shaft to the rotating member.

The transformation mechanism is subject to constraining reactions transmitted by the translating portion acting on the hydraulic pump, which are discharged onto the housing of the linear actuator.

Specifically, in the known solutions, the constraining reactions transmitted by the translating portion are discharged onto the bearing, which rotationally supports the transformation mechanism. Thus, the bearing is locked inside the housing of the linear actuator by means of a locking element, which is axially interposed between the bearing and the reduction gear, such as a locking ring, for example.

Therefore, this type of solutions, along a longitudinal extension direction of the electro-hydraulic actuator, provide in cascade the motor, the reduction gear, the locking element, the bearing, and the transformation mechanism comprising the rotating member and the translating thrust member, which must be correctly assembled and inserted into appropriate seats in the housing which delimits the electro-hydraulic linear actuator.

A need felt in the industry is to manufacture electro-hydraulic actuators for brakes which allow simplified assembly, reduced components, as well as reduced weight and size, with equal performance of the electro-hydraulic actuator for a brake.

Therefore, a need strongly felt in the industry is to provide solutions of electro-hydraulic actuators which, at least with equal performance, are more compact, lighter, and have a small number of components while allowing a simplified assembly compared to the known solutions.

### Solution

The present invention aims to provide an electro-hydraulic actuator, preferably a linear actuator, for a braking system of a vehicle, e.g., of the Brake by Wire type.

This and other objects and advantages are achieved by an electro-hydraulic actuator according to claim 1, as well as by a braking system according to claim 10.

Some advantageous embodiments are the subject of the dependent claims.

By virtue of the suggested solutions, it is possible to ensure a higher compactness of the electro-hydraulic actuator, reducing the number of components compared to the known solutions.

By virtue of the suggested solutions, it is possible to ensure a simplified assembly of the mechanism for transforming the rotary motion of the drive shaft into a translation of the translating portion acting on a brake fluid, while reducing the assembly times for electro-hydraulic actuators with equal performance.

By virtue of the suggested solutions, it is possible to provide a single mechanical component, which integrates several functions, that of axially locking a bearing of the transformation mechanism in the actuator housing and simultaneously a reduction unit adapted to demultiply the rotary motion of the drive shaft.

### DRAWINGS

Further features and advantages of the electro-hydraulic actuator and the braking system will be apparent from the description below of preferred embodiments thereof, given by way of non-limiting indication, with reference to the accompanying drawings, in which:

FIG. 1 shows an axonometric view of an electro hydraulic actuator for a braking system according to the present invention;

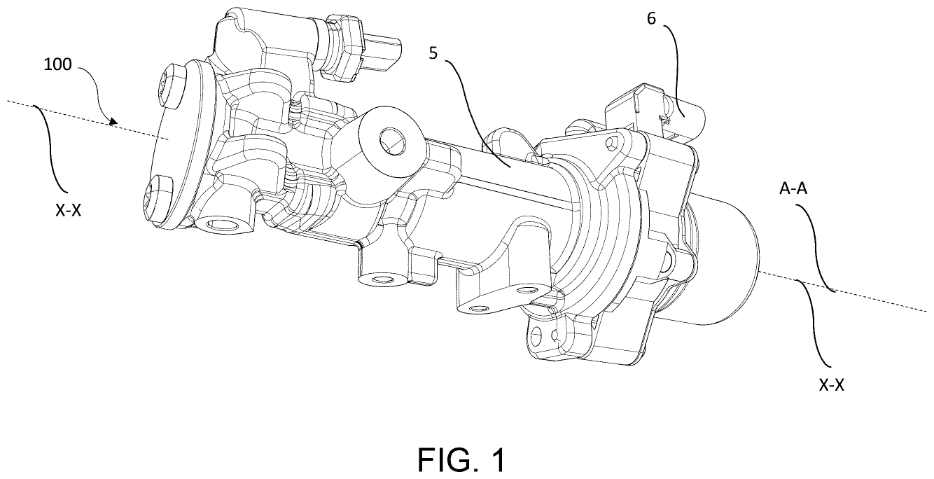

FIG. 2 shows an exploded axonometric view of the actuator in FIG. 1, sectioned along a cutting plane passing through the axial direction X-X along which a float adapted to act on a brake fluid is movable;

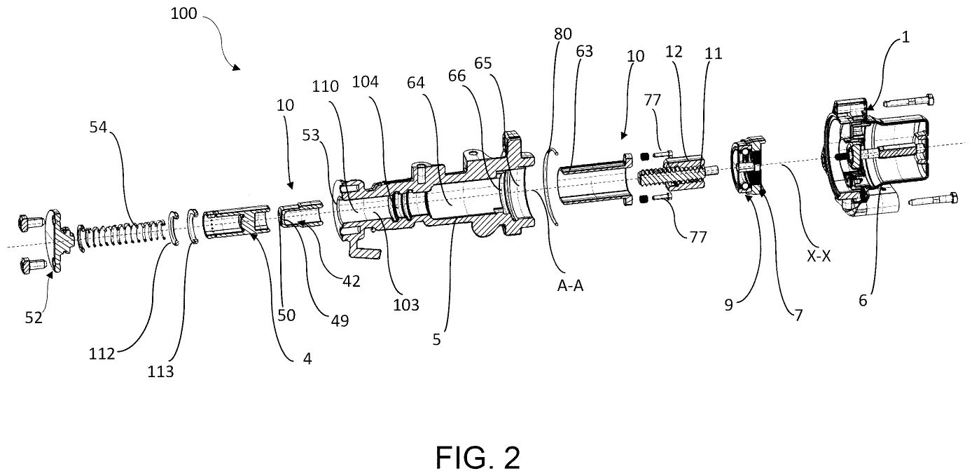

FIG. 3 shows a sectioned side view of the electro-hydraulic actuator, sectioned along a cutting plane passing through the axial direction X-X in FIG. 1;

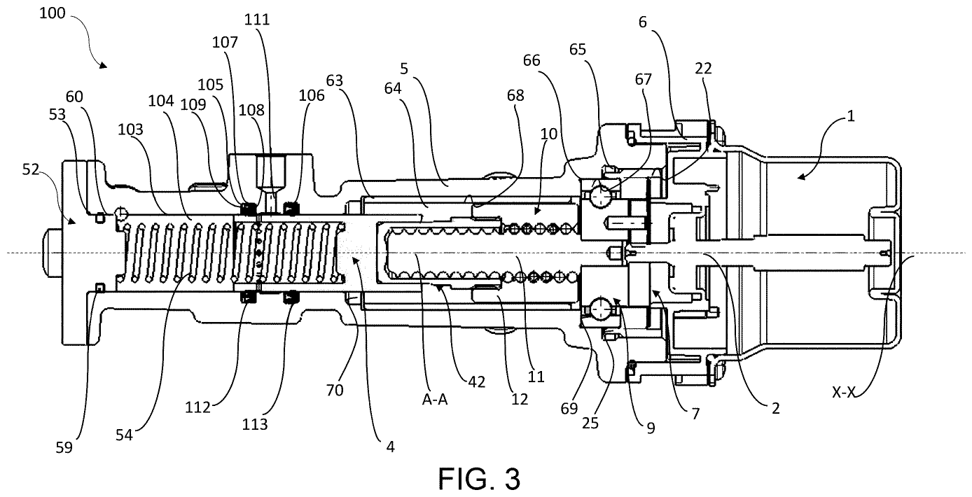

FIG. 4 shows a detail of the section in FIG. 3;

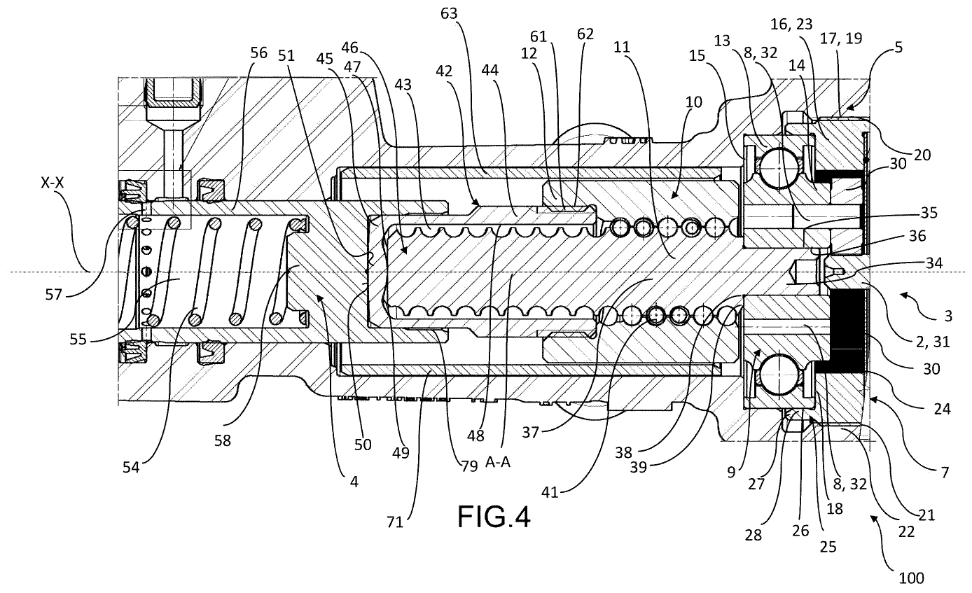

FIGS. 5 and 6 show axially opposite axonometric views of a gear of a reduction unit, adapted to be constrained to a first housing of the electro-hydraulic actuator by packing a bearing adapted to rotationally support a transformation unit so as to axially lock it and receive the constraining reactions transmitted from the transformation unit to the bearing;

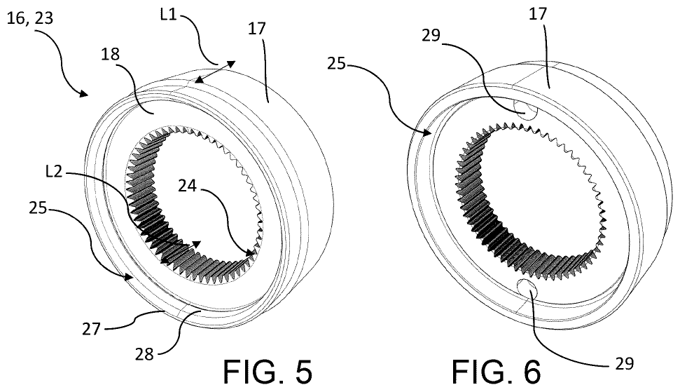

FIGS. 7 and 8 show axially opposite axonometric views of the transformation unit, such as screw-nut assembly with recirculating balls, comprising a rotating member, e.g., a screw, mechanically couplable to a translating thrust member, e. g., a nut, for example by means of a plurality of balls, to allow a translation of the thrust member upon a rotation of the rotating member adapted to receive the rotation of the electric motor, a thrust cap adapted to be integral with the thrust member and come into contact with the float and pressurize, for example, a brake fluid in a pressure chamber connected to a braking device, and adapted to reduce friction between the rotating member and the thrust member, and an anti-rotation sleeve shaped so as to be inserted into the housing rotationally locked with respect to the first housing and so as to achieve a shape-coupling with the thrust member, for example by means of at least one flat surface, preferably two flat surfaces, directing a low-friction and rotation-proof translation of the thrust member, e. g., with at least one or more corresponding flat surfaces thereof;

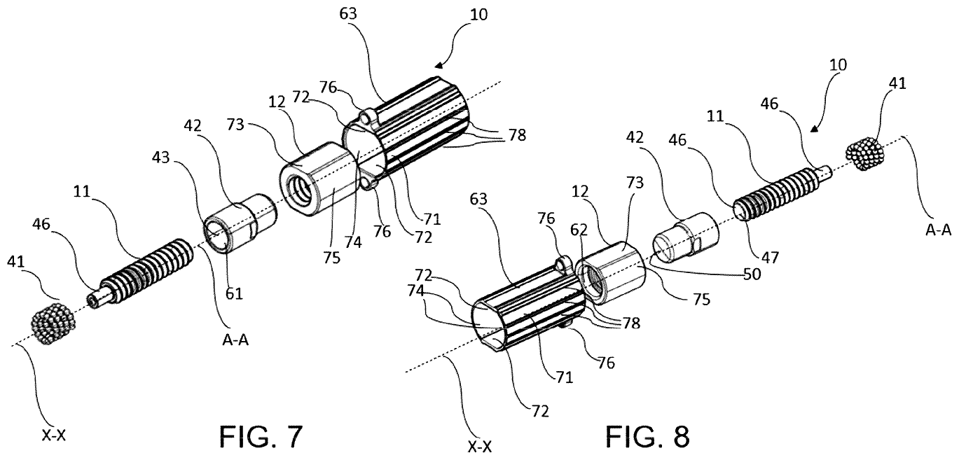

FIG. 9 is a detail of the section in FIG. 3, in which the bearing is shown, being held in the axial position thereof at least when subject to constraining reactions transmitted from the transformation unit to the bearing, from the constrained reduction unit to the first housing and configured to receive, from the bearing, the constraining reactions transmitted from the transformation unit.

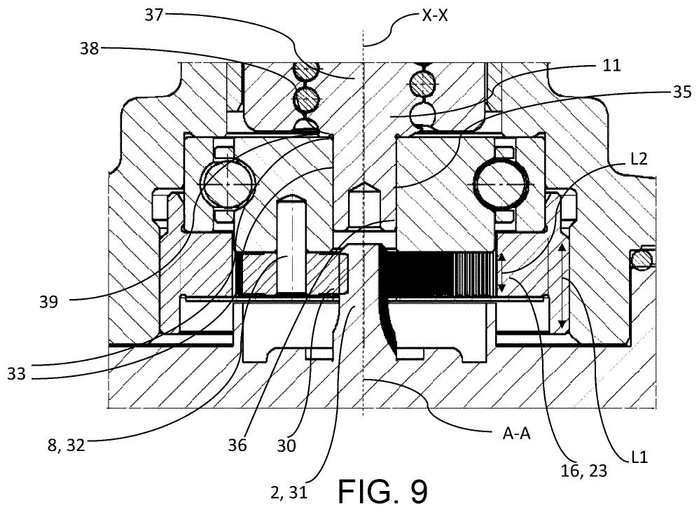

### DESCRIPTION OF SOME PREFERRED EMBODIMENTS

According to a general embodiment, an electro-hydraulic actuator for actuating a brake caliper, in particular of a disc brake of a vehicle with two or more wheels, is generally indicated by reference numeral 100.

The electro-hydraulic actuator 100 comprises an electric motor 1 with a drive shaft 2.

The electro-hydraulic actuator comprises a transformation mechanism 3 connected to the drive shaft 2 to transform a rotary motion of the drive shaft 2 into a linear translatory motion along an axial direction X-X of float 4 of a hydraulic pump or brake master cylinder of said brake to pressurize a brake fluid.

The electro-hydraulic actuator comprises a first housing 5 configured to accommodate the transformation mechanism 3 and support a second housing 6 of the electric motor 1. In an embodiment, the electro-hydraulic actuator 100 comprises the second housing 6, where the second housing 6 is coupled to the first housing 5. According to an embodiment, the electro-hydraulic actuator 100 comprises a sealing gasket 80 interposed between the second housing 6 and at least one shoulder of the first housing 5.

The transformation mechanism 3 comprises a reduction unit 7 with at least one output interface 8 and configured to demultiply the rotary motion of the drive shaft 2 and transmit it to the at least one output interface 8.

The transformation mechanism 3 comprises a transformation unit 10 for converting the rotary motion of the at least one output interface 8 into a translatory motion of the float 4.

The transformation unit 10 comprises a rotating member 11, which is connected to the at least one output interface 8, and a thrust member 12, which is linearly translatable, where the rotating member 11 is mechanically coupled to the thrust member 12 so as to transform a rotation of the rotating member 11 into a linear translation of the thrust member 12 which allows a displacement in the axial direction X-X of the float 4.

The transformation mechanism 3 comprises a bearing 9 connected to the rotating member 11 and to the first housing 5 to allow the rotation of the rotating member 11 with respect to the first housing 5.

Advantageously, the bearing 9 is packed between a first-housing shoulder 15 and said reduction unit 7 by constraining the bearing 9 in the first housing 5, so that a constraining reaction of the transformation unit 10 due to the action of the float 4 on the brake fluid is discharged directly onto the reduction unit 7.

By virtue of the provision of the reduction unit 7 constrainable to the first housing, it is possible to constrain the bearing inside the first housing without using additional mechanical stop components for locking the bearing 9 in the seat thereof defined by the first housing, with a clearance equal to an assembly gap, or without clearance.

In an embodiment, the reduction unit 7 is constrained to the first housing 5, locking the bearing 9 with clearance in the seat thereof defined by the first housing leaving an assembly gap between the reduction unit and the bearing 9. For example, the assembly gap is defined by an axial distance between the bearing 9 when directly or indirectly abutting against a first-housing shoulder 15 and the reduction unit when constrained in a position of complete assembly with the first housing. For example, the assembly gap is less than a millimeter, preferably less than half a millimeter. It is thus possible to avoid pre-load conditions, e.g., axial pre-load, for the bearing 9 and/or the reduction unit 7. The bearing 9, receiving the constraining reaction of the transformation unit 10 due to the action of the float 4 on the brake fluid, thus recovers the assembly gap and directly discharges onto the reduction unit 7 thus abutting against the reduction unit 7.

In an embodiment, the reduction unit 7 is constrained to the first housing 5 thus abutting against the bearing 9 and locks the bearing 9 in the seat thereof defined by the first housing without clearance.

In an embodiment, said reduction unit 7 comprises at least one rotationally locked reduction gear 16. In an embodiment, the reduction gear 16 comprises a reduction gear coupling portion 17 to form an integral connection with the first housing 5 of the transformation mechanism 3 configured to constrain, e.g., axially to prevent axial movements, the at least one reduction gear 16 inside the first housing 5.

By virtue of the provision of the reduction gear coupling portion 17 it is possible to constrain the reduction gear to the first housing 5, locking the rotation and the axial movements of the reduction gear 16, so that the bearing 9 is locked in the seat thereof, with or without clearance, discharging the constraining reactions due to the action of the float 4 directly onto the reduction gear 16.

According to an embodiment, the reduction gear coupling portion 17 comprises a thread. It is thus possible to screw the reduction gear 16 and/or the crown wheel 23 inside the first housing 5 until the abutment is achieved, or leave an assembly gap, with the reduction gear abutment portion against the bearing 9, thus ensuring the axial fixing of both the reduction gear 16 and/or the crown wheel 23 and the bearing.

In an embodiment, the reduction gear 16 comprises an abutment portion 18 adapted to abut against the bearing 9 forming an axial constraint for the bearing 9.

In an embodiment, the bearing 9 is tightened between the abutment portion 18 and the first-housing shoulder 15, either with or without clearance, so that the constraining reaction of the transformation unit 10 due to the action of the float 4 on the brake fluid is discharged directly onto the abutment portion 18 and indirectly on the first housing 5.

In an embodiment, the bearing 9 is a ball bearing.

In an embodiment, said reduction gear coupling portion 17 comprises at least one threaded portion 19 obtained on a radially outer reduction gear wall 21 of the reduction gear 16, which is adapted to be connected to a threaded counter-portion 20 obtained on a first radial wall 22 of said first housing 5, so as to constrain, for example axially to prevent movements along the axial direction X-X, the reduction gear 16 in the first housing 5, for example up to abut the reduction gear abutment portion 18 against the bearing 9 or reach a position of complete assembly, for example abutting against a first-housing shoulder, leaving an assembly gap between the reduction gear abutment portion 18 and the bearing 9.

In an embodiment, said reduction gear coupling portion 17 comprises a bayonet connection portion to be connected to a bayonet connection counter-portion obtained in a first radial wall 22 of said first housing 5, so as to constrain, for example axially to prevent movements along the axial direction X-X, the reduction gear 16 in the first housing 5 up to abut the reduction gear abutment portion 18 against the bearing 9.

In an embodiment, the reduction gear abutment portion 18 is an annular surface which axially delimits the reduction gear 16.

In an embodiment, said reduction unit 7 comprises a reduction gear 16, said reduction gear 16 comprising a crown wheel 23 with internal one-piece toothing and rotationally locked to the first housing 5.

In an embodiment, the electric motor 1 and the transformation mechanism 3 are arranged in cascade along said axial direction X-X.

In an embodiment, the bearing 9 comprises a fixed bearing portion 13 rotationally locked to the first housing 5 and a rotating bearing portion 14, which is rotatable with respect to the fixed bearing portion 13. In an embodiment, the fixed bearing portion 13 is a ring. In an embodiment, the rotating bearing portion 14 is a disc.

In an embodiment, the rotating bearing portion 14 is connected to the at least one output interface 8 so as to integrally rotate with the at least one output interface 8. In an embodiment, the rotating bearing portion 14 comprises the output interface 8.

In an embodiment, the rotating member 11 is connected to the rotating bearing portion 14 so as to rotate integrally with the rotating bearing portion 14.

In an embodiment, the bearing 9 is axially constrained inside the first housing 5 with the fixed bearing portion 13 abutting on one side against the first-housing shoulder 15 and on the other side against a reduction gear abutment portion 18 of the reduction unit 7.

In an embodiment, said crown wheel 23 with internal toothing comprises the reduction gear coupling portion 17 to form an integral connection with the first housing 5, axially locking the crown wheel 23 inside the first housing 5.

In an embodiment, said crown wheel 23 with internal toothing comprises a reduction gear abutment portion 18 adapted to abut and/or abuttingly receive the fixed bearing portion 13 thus axially locking the bearing 9 inside the first housing 5 so that the axial reaction of the transformation unit 10 due to the action of the float 4 on the brake fluid is discharged onto the reduction gear abutment portion 18 of said crown wheel 23.

In an embodiment, said crown wheel 23 with internal toothing comprises an interlocking portion 25 adapted to interfere with a radially outer bearing wall 26 of the fixed bearing portion 13 to radially tighten the fixed bearing portion 13. In an embodiment, said crown wheel 23 with internal toothing comprises an interlocking portion 25 adapted to accommodate, with clearance, a radially outer bearing wall 26 of the fixed bearing portion 13 to center a wheelbase of the pins of the bearing with the axis of the crown wheel 23.

In an embodiment, the reduction gear abutment portion 18 forms a shoulder for the interlocking portion 25, where the interlocking portion 25 axially projects in a cantilevered manner from the reduction gear abutment portion 18.

In an embodiment, said interlocking portion 25 comprises a flared portion 27 adapted to accommodate and forming a leading taper for a centered insertion of the fixed bearing portion 13 into the interlocking portion 25.

In an embodiment, said interlocking portion 25 comprises a contact portion 28 adapted to interfere and/or face the radially outer bearing wall 26 of the fixed bearing portion 13 to radially tighten the fixed bearing portion 13 and/or center the bearing 9 with the crown wheel 23.

In an embodiment, said crown wheel 23 comprises a central crown portion 24 having an internal toothing.

In an embodiment, the reduction gear coupling portion 17 extends axially over an axial coupling length L1, which is greater than an axial central portion length L2 along which the central crown wheel portion 24 axially extends. In an embodiment, the crown wheel 23 comprises at least one connection seat 29, such as a blind hole made on a surface axially opposite to the reduction gear abutment portion 18, adapted to receive a tool to connect, e.g., to screw, the crown wheel 23 to the first housing 5. In an embodiment, the reduction gear coupling portion 17 extends axially over an axial coupling length L1, which is smaller than an axial central portion length L2 along which the central crown wheel portion 24 axially extends.

In an embodiment, said reduction 7 comprises an epicyclic reduction gear or a harmonic reduction gear.

In an embodiment, said reduction unit 7 comprises at least a first reduction portion, which includes at least a first reduction stage, operatively associated with said crown wheel 23 with internal toothing.

In an embodiment, said reduction unit 7 comprises at least one planetary gear wheel train 30, and a central pinion 31 integral with and/or formed by the end of the drive shaft 2 and having an external toothing, where the planetary gear wheels 9 of the at least one planetary gear wheel train 9 mesh with both the central pinion 31 and the crown wheel 23.

In an embodiment, each planetary gear wheel 9 rotates about a planet gear pin or pivot 32. In an embodiment, each planet gear pin 32 is constrained to the rotating bearing portion 14. In an embodiment, the rotating bearing portion 14 comprises a satellite holder plate. In an embodiment, said at least one output interface 8 comprises each planet gear pin 32. In an embodiment, each planet gear pin 32 rotates on the same circumference about the axial direction X-X.

In an embodiment, the rotating member 11 comprises a shank portion 34. In an embodiment, the t shank portion 34 has a side surface 35 laterally delimiting the shank portion. In an embodiment, said bearing 9 comprises a connection hole delimited by a connection hole surface 36. In an embodiment, the shank portion 34 is adapted to be connected to the connection hole.

In an embodiment, the rotating member 11 is connected to the bearing 9 by shape coupling. In an embodiment, the side surface 35 of the shank portion 34 and the connection hole surface 36 are polygonal surfaces adapted to be shape-coupled. For example, the side surface 35 of the shank portion 34 and the connection hole surface 36 are prismatic surfaces having a star-shaped base. According to an embodiment, the shank portion 34 is a star prism. In an embodiment, the connection hole delimits a star prism.

In an embodiment, the rotating member 11 is connected to the bearing 9 by mechanical interference coupling and comprises plastically deformed portions 33 in contact with the bearing 9, avoiding a shape coupling, so that the bearing 9 transfers a torque to the rotating member 11 by mechanical interference coupling and so that the rotating member 11 is supported by the bearing 9 discharging a constraining reaction of the transformation unit 10 due to the action of the float 4 on the brake fluid directly onto the bearing 9.

By virtue of the provision of the mechanical interference coupling, i.e., a force coupling, between the rotating member 11, such as a screw of a screw-nut assembly, it is possible to simplify the processing of the connection system between the rotating member 11 and the bearing 9, avoiding making polygonal geometric shapes for shape-coupling a portion of the rotating member 11 to a portion of the bearing 9.

In an embodiment, the shank portion 34 is cylindrical. In an embodiment, the shank portion 34 has an unsuitable shape to transfer a torque by shape coupling.

In an embodiment, said connection hole surface 36 is a cylindrical surface.

In an embodiment, the shank portion 34 comprises said plastically deformed portions 33 in contact with said connection hole surface 36.

In an embodiment, the rotating member 11 comprises a rotating body 37. In an embodiment, the shank portion 34 is connected to the rotating body 37 extending in a cantilevered manner from the rotating body 37 along the thrust direction A-A.

In an embodiment, the rotating body 37 comprises mechanical coupling means to be coupled to the thrust member 12.

In an embodiment, the rotating member 11 comprises an annular depression 38 on the rotating body 37 which surrounds the shank portion 34.

In an embodiment, the rotating member comprises an annular ridge 39 on the rotating body 37, where the annular ridge 39 abuts along the thrust direction A-A against a bearing abutment surface 40 opposite to the reduction unit 7.

In an embodiment, the transformation unit 10 is a screw-nut assembly, preferably with recirculating balls.

In an embodiment, the transformation unit 10 is a ball-in-ramp device.

In an embodiment, the rotating member 11 is a screw with a helical external thread. In an embodiment, the thrust member 12 is a nut comprising a helical internal thread. In an embodiment, the transformation unit 10 comprises a plurality of balls 41 arranged in contact between the helical internal thread and the helical external thread, where the thrust member 12 defines a recirculation channel for moving the balls 41.

In an embodiment, the transformation unit 10 has a central axis A parallel to or coincident with the axial direction X-X.

In an embodiment, the transformation unit 10 comprises a thrust cap 42 integrally connected to the thrust member 12 so that it translates linearly and integrally with the thrust member 1 between a resting configuration and a thrust configuration.

In an embodiment, the thrust cap 42 is configured to contact the float 4 and transfer a thrust action to the float 4.

In an embodiment, the thrust cap 42 extends in a cantilevered manner from the thrust member 12 and forms a cap cavity 43 adapted to accommodate the rotating member 11.

In an embodiment, the thrust cap 42 comprises a cap side wall 44 and a cap bottom wall 45. The cap side wall 44 comprises an inner cap side surface 48 radially delimiting the cap cavity 43 facing the rotating member 11 without mechanical couplings. The cap bottom wall 45 comprises an inner bottom cap surface 49 axially delimiting the cap cavity 43 facing a free end 46 of the rotating member 11.

The cap bottom wall 45 comprises an outer bottom cap surface 50 axially opposite to the inner bottom cap surface 49 and configured to contact the float 4 and transfer a thrust action to the float 4.

In an embodiment, the inner bottom cap surface 49 is tapered along said central axis A towards the free end 46 of the rotating member 11 so as to contact the free end 46 of the rotating member 11 only partially and about the central axis A.

In the resting configuration, the inner bottom cap surface 49 is in contact with the free end 46 defining a mechanical stop of the electro-hydraulic actuator 100.

In the thrust configuration, the outer bottom cap surface 50 and the float surface 4 are in contact transferring an axial force from the thrust member 12 to the float 4.

By virtue of the contact, at the central axis A between the tapered inner bottom cap surface 49 and the free end surface 46 facing the thrust cap 42, it is possible to ensure a mechanical stop for the electro-hydraulic actuator in the resting position thereof, with the thrust member 12 in the original or zero position from which it cannot be further retracted.

By virtue of the contact, at the central axis A between the tapered inner bottom cap surface 49 and the free end surface 46 facing the thrust cap 42, it is possible to limit the contact between the thrust cap 42 and the rotating member 11 to a surface portion about the central axis A, which is smaller than a section of the rotating member perpendicular to the axial direction X-X and/or to an exposed surface of the free end 46 of the rotating member 11 facing the axial direction X-X, and at most, it is possible to limit the contact between the thrust cap 42 and the rotating member 11 in a surface portion coincident with the point of contact through which the central axis A passes. In this manner, by reducing the contact surface between the thrust cap 42 and the rotating member 11, it is possible to facilitate the translation of the thrust cap 42 under the action of the rotating member 11 after reaching the mechanical stop between the two components, i.e., it is possible to reduce the static friction torque between the free end 46 of the rotating member 11 and the thrust cap 46 to be overcome, in order to allow a rotation of the rotating member 11 and the corresponding translation of the thrust cap 42, thus reducing or preventing seizures between the two contact surfaces.

In an embodiment, the outer bottom cap surface 50 is tapered along said central axis A towards the float 4 so as to contact the float 4 only partially and about the central axis A.

In an embodiment, the inner bottom cap surface 49 and the outer bottom cap surface 50 are tapered along said central axis A in opposite directions towards the free end 46 of the rotating member 11 and towards the float 4, respectively, so as to contact the free end 46 of the rotating member 11 and the float 4 only partially and about the central axis A, respectively.

By virtue of the provision of the outer bottom cap surface 50 tapered in the direction of the float 4 along the axial direction X-X with respect to the central axis A, it is possible to transfer the translation force of the thrust cap 42 generated by the coupling of the rotating member 11 of the thrust member 12, about the central axis A and at most on the central axis A.

In an embodiment, the inner bottom cap surface 49 is a curved surface centered on the central axis A. In an embodiment, the inner bottom cap surface 49 is a curved surface having a maximum centered on the central axis A. In an embodiment, the inner bottom cap surface 49 is a curved surface having the radius R 1 centered on the central axis A.

In an embodiment, the outer bottom cap surface 50 is a curved surface centered on the central axis A. In an embodiment, the outer bottom cap surface 50 is a curved surface having a maximum centered on the central axis A. In an embodiment, the outer bottom cap surface 50 is a curved surface having the radius R 2 centered on the central axis A.

In an embodiment, the radius R1 of (the inner bottom surface 49 is smaller than the centered radius R 2 of the outer bottom cap surface 50.

In an embodiment, the inner bottom cap surface 49 and the outer bottom cap surface 50 are curved surfaces, having opposite concavity.

In an embodiment, the inner bottom cap surface 49 is at least partially a cap surface of a sphere and/or a spheroid and/or an ellipsoid having a maximum centered on said central axis A and concavity facing said outer bottom cap surface 50, so that the maximum of the inner bottom cap surface 49 is configured to come into contact with the rotating member.

In an embodiment, the outer bottom cap surface 50 is at least partially a cap surface of a sphere and/or a spheroid and/or an ellipsoid having a maximum centered on said central axis A and concavity facing the inner bottom cap surface 49.

In an embodiment, the inner bottom cap surface 49 and the outer bottom cap surface 50 are at least partially cap surfaces of a sphere and/or a spheroid and/or an ellipsoid, axially opposite, with the vertex at said central axis A.

By providing a curved inner bottom cap surface 49, it is possible to increase the curvature and/or reduce the radius of such a surface, facilitating the translation of the thrust cap 42 under the action of the rotating member 11 after reaching the mechanical stop between the two components, i.e., it is possible to reduce the static friction torque between the free end 46 of the rotating member 11 and the thrust cap 46 to be overcome, in order to allow a rotation of the rotating member 11 and the corresponding translation of the thrust cap 42, thus reducing or preventing seizures between the two surfaces in contact.

In an embodiment, said free end 46 of the rotating member 11 comprises a central free end surface 47. In an embodiment, the central free end surface 47 is flat and perpendicular to the central axis A. In an embodiment, the central free end surface 47 is tapered along said central axis A towards the inner bottom cap surface 49 so as to contact the inner bottom cap surface 49 only partially and about the central axis A. In an embodiment, the central free end surface 47 is a curved surface centered on the central axis A. In an embodiment, the central free end surface 47 is a curved surface having a maximum centered on the central axis A. In an embodiment, the central free end surface 47 is a curved surface having the radius R3 centered on the central axis A. In an embodiment, the central free end surface 47 is at least partially a cap surface of a sphere and/or a spheroid and/or an ellipsoid having a maximum centered on said central axis A.

In an embodiment, in the resting configuration, the inner bottom cap surface 49 is in contact with the central free end surface 47.

In an embodiment, said float 4 delimits a float coupling seat 79 adapted to partially accommodate, with clearance, the thrust cap 42. The float 4 comprises a central float surface 51 axially delimiting the float coupling seat 79.

In an embodiment, the central float surface 51 is flat and perpendicular to the central axis A.

In an embodiment, the central float surface 51 is tapered along said central axis A towards the outer bottom cap surface 50 so as to contact the outer bottom cap surface 50 only partially and about the central axis A. In an embodiment, the central float surface 51 is a curved surface centered on the central axis A. In an embodiment, the central float surface 51 is a curved surface having a maximum centered on the central axis A. In an embodiment, the central float surface 51 is a curved surface having the radius R 3 centered on the central axis A. In an embodiment, the central float surface 51 is at least partially a cap surface of a sphere and/or a spheroid and/or an ellipsoid having a maximum centered on said central axis A.

In the thrust configuration, the outer bottom cap surface 50 and the central float surface 51 are partially in contact transferring an axial force from the thrust member 12 to the float 4.

In an embodiment, the thrust cap 42 is made in one piece with said thrust member 12.

In an embodiment, the thrust cap 42 is made in one piece separate from said thrust member 12. In an embodiment, the thrust cap 42 and said thrust member 12 are made of different materials. In an embodiment, the thrust cap 42 is made of steel or aluminum, and said thrust member 12 is made of alloy steel.

In an embodiment, the thrust c comprises a cap coupling portion 61 adapted to be shape-coupled to a thrust member coupling counter-portion 62 of said thrust member 12, for example, by threading or by bayonet or interference coupling.

In an embodiment, the cap coupling portion 61 is a radially outer thread made on an end portion of the cap side wall 44 on the outer cap side surface.

In an embodiment, the thrust member coupling counter-portion 62 is made on a radially inner surface of the thrust member 12.

In an embodiment, each section of the thrust cap 42 has a smaller radial dimension than each section of the thrust member 12, avoiding direct or indirect interference of the cap side wall 44 with the first housing 5 or with an anti-rotation device 63 on which the thrust member 12 translates at low friction.

In an embodiment, each axial projection or orthogonal projection along said axial direction X-X of the thrust cap 42 is completely contained within each section of the thrust member 12, avoiding direct or indirect interference of the cap side wall 44 with the first housing 5 or with an anti-rotation device 63 on which the thrust member 12 translates at low friction.

By virtue of the provision of the thrust cap 42 it is possible to limit the axial extension of the thrust member 12, e.g., of the nut, and limit the weight of the transformation unit 10, and also limit the surfaces involved to the contact friction during the translation of the thrust member 42, only to the surfaces of the thrust member 42 in contact with the first housing 5 or with the surfaces of the anti-rotation device 63.

In an embodiment, the transformation unit 10 comprises an anti-rotation sleeve 63 housed in said first housing 5 and constrained to the first housing 5 and rotationally locked.

In an embodiment, the anti-rotation sleeve 63 delimits, with an anti-rotation side wall 71 thereof, an open cavity adapted to accommodate the transformation unit 10 so as to avoid direct contact between the thrust member 12 and the first housing 5.

In an embodiment, the anti-rotation side wall 71 comprises at least one flat straight anti-rotation surface 72 parallel to the axial direction X-X and adapted to face and slide, at low friction, on a respective flat straight thrust member surface 73 parallel to the axial direction X-X.

In an embodiment, the anti-rotation side wall 71 comprises at least two straight flat anti-rotation surfaces 72 parallel to the axial direction X-X adapted to face each other and slide, at low friction, on respective straight flat thrust member surfaces 73 parallel to the axial direction X-X.

In an embodiment, the anti-rotation side wall 71 comprises at least one curvilinear anti-rotation surface 74 parallel to the axial direction X-X, which connects the straight flat anti-rotation surface 72 on opposite sides.

In an embodiment, the anti-rotation side wall 71 comprises at least two curvilinear anti-rotation surfaces 74 parallel to the axial direction X-X, which connect the straight anti-rotation surfaces 72.

In an embodiment, the thrust member 12 comprises thrust member surfaces 75 adapted to face the curvilinear anti-rotation surfaces 74 without coming into contact therewith, so that the thrust member slides in contact with the straight anti-rotation surfaces 72.

In an embodiment, the two straight anti-rotation surfaces 72 face each other.

In an embodiment, the anti-rotation side wall 71, outside or on the radially outer side or on the side opposite to the delimited open cavity, comprises a plurality of axial ribbings 78. In an embodiment, the axial ribbings 78 are configured to center the anti-rotation sleeve 63 housed inside said first housing 5. In an embodiment, the axial ribbings 78 are configured to contact, with clearance or interference, the third radial wall 68 of first housing, delimiting a transformation unit seat 64, so as to connect, by rotationally locking, the anti-rotation sleeve 63 with the first housing 5.

In an embodiment, the anti-rotation sleeve 63 comprises at least one fixing flange 76 projecting in a cantilevered manner from the anti-rotation side wall 71, where the fixing flange 76 is adapted to be integrally constrained to the first housing 5. In an embodiment, the fixing flange 76 is adapted to be inserted into a respective seat obtained in the third radial wall 68 of first housing and in the second shoulder 69 of first housing.

In an embodiment, the anti-rotation sleeve 63 comprises two radially opposite fixing flanges 76 adapted to be inserted into appropriate seats obtained in the third radial wall 68 of first housing and in the second shoulder 69 of first housing. In an embodiment, the fixing flanges 76 are shape-coupled to the appropriate seats or mechanically coupled by means of fixing screws 77 to the appropriate seats.

In an embodiment, said anti-rotation sleeve 63 is made of a low-friction polymer material.

In an embodiment, said anti-rotation sleeve 63 is made of a metal material, e.g., steel or aluminum.

In an embodiment, said first housing 5 comprises a first radial wall 22 of first housing which delimits a reduction unit seat 65.

In an embodiment, said first housing 5 comprises a second radial wall 67 of first housing defining a bearing seat 66.

In an embodiment, said first housing 5 comprises a third radial wall 68 of first housing defining a transformation unit seat 64.

In an embodiment, said transformation unit seat 64 is in communication with the float seat 104 and with the reduction unit seat 65 and with the bearing seat 66.

In an embodiment, the first radial wall 22 of first housing is connected to said second radial wall of first housing 67 by means of a first shoulder 15 of first housing.

In an embodiment, the second radial wall 67 of first housing is connected to said third radial wall 68 of first housing by means of a second shoulder 69 of first housing.

In an embodiment, the third radial wall 68 of first housing is connected to the cylinder wall 104 by means of a third shoulder 70 of first housing.

In an embodiment, the first housing 5 houses in cascade along the axial direction X-X: the reduction unit 7, the transformation unit 10, and the float 4.

In an embodiment, the first housing 5 delimits, at one end thereof, downstream of said float 4, an axial first-housing opening 53 on the side axially opposite to said electric motor 1.

In an embodiment, the electro-hydraulic actuator 100 comprises a hydraulic cap 52 fluid-tightly connected to said first housing 5 to close the axial first-housing opening 53. In an embodiment, said first housing 5 is made in one piece.

In an embodiment, the hydraulic cap 53 is made in a separate piece from said first housing 5.

In an embodiment, the sum of the axial extensions along the axial direction X-X of the reduction unit seat, the bearing seat and the transformation unit seat is greater than the axial extension of the float seat.

In an embodiment, the axial extension of the float seat is less than half the axial extension of the first housing 5.

By virtue of the provision of the hydraulic cap 52, it is possible to manufacture electro-hydraulic actuators 100 having a first housing 5 made in one piece having a great extension along the axial direction X-X, adapted to delimit a float seat, a transformation unit seat, a bearing seat and a reduction unit seat, simultaneously ensuring the possibility of internally processing, with high precision, the cylinder wall of the float seat without passing through the reduction unit seat, the bearing seat and the transformation unit seat with the work tools.

In an embodiment, the reduction unit 7, the transformation unit 10, and the float 4 are coaxial.

In an embodiment, the electro-hydraulic actuator 100 comprises an elastic element 54 housed inside said first housing 5 interposed between said hydraulic cap 52 and said float 4, constantly biasing said float 4 in the opposite direction to a float feeding direction.

In an embodiment, the electro-hydraulic actuator 100 comprises a hydraulic cap gasket 59 arranged between a hydraulic cap side wall 60 of the hydraulic cap 52 and the cylinder wall 103, so as to form a seal in the pressure chamber 110.

In an embodiment, said hydraulic cap 53 has a T-shaped section.

In an embodiment, the first housing 5 comprises a cylinder wall 103 internally delimiting a float seat 104.

In an embodiment, the cylinder wall 103 delimits a pressure chamber 110 fluidly connectable to a braking device. In an embodiment, the cylinder wall 103 delimits a primary gasket seat 105 and a secondary gasket seat 106.

In an embodiment, the first housing 5 defines a supply conduit 111 fluidly connectable to a tank and/or to a fluid feeding valve. Said supply conduit 111 leads into a supply opening 112 on said cylinder wall 103 between said primary gasket seat 105 and said secondary gasket seat 106.

In an embodiment, the primary gasket seat 105 is delimited radially by an axial seat wall 107 and axially by a first radial seat wall 108 and a second radial wall 109, connected as an undercut to said axial seat wall 107.

In an embodiment, the electro-hydraulic actuator 100 comprises the float 4. In an embodiment, the float 4 is slidingly housed in a sealing manner in the float seat 104 to pressurize a fluid in a pressure chamber 110 fluidly connectable to a braking device.

In an embodiment, the electro-hydraulic actuator 100 comprises a primary gasket 1.

In an embodiment, said primary gasket 1 is housed in said primary gasket seat 105 with axial clearance between said first radial seat wall 108 and said second radial wall 109. In an embodiment, when said primary gasket 1 abuts against said first radial seat wall 108, it is configured to form a seal with said float 102 and said primary seat axial wall 107, thus fluidly isolating the pressure chamber 110 and the supply conduit 111. In an embodiment, when said primary gasket 1 abuts against said second radial wall 109, it is configured to form a seal with said float 102, avoiding the formation of a seal with said primary seat axial wall 107, to fluidly connect the supply conduit 111 and the pressure chamber 110 to increase the fluid pressure in the pressure chamber. In an embodiment, said primary gasket is a three-lip gasket.

In an embodiment, the electro-hydraulic actuator 100 comprises a secondary gasket 113, where the secondary gasket 113 is housed in the secondary gasket seat 106 to form a static and dynamic seal with said float 102 and said cylinder Wall 103. In an embodiment, for example, said secondary gasket 113 is two-lip gasket.

According to an embodiment, the float 4 is axially movable between a float resting configuration and at least one advanced float configuration to pressurize a fluid, such as a brake fluid, in the pressure chamber 110.

In an embodiment, the float 4 comprises a first hollow float portion 55 delimited by a radial float wall 56. In an embodiment, the first hollow float portion 55 is in fluid connection with the pressure chamber 110. In an embodiment, the radial float wall 56 has at least one through radial opening 57.

In an embodiment, the float 4 delimits, with said radial float wall 56, a second hollow float portion, comprising said float coupling seat 79.

In an embodiment, the float 4 comprises an axial float wall 58, where the axial float wall 58 axially delimits, on the one side, the first hollow float portion 55 and, on the opposite side, the float coupling seat 79.

In an embodiment, the elastic element 54 is interposed between said hydraulic cap 52 and the axial float wall 58, constantly biasing said float 4 in the opposite direction to a float feeding direction.

In an embodiment, until said float 4 is arranged with said through radial opening 57 arranged between the primary gasket 112 and the secondary gasket 113, the pressure chamber 110 is in fluid communication with said supply conduit 111 by means of said through radial opening 57,

In an embodiment, when said float 4 is in said advanced float configuration, with said through radial opening 57 arranged to be axially advanced with respect to the primary gasket 112, the pressure chamber 110 is fluidly isolated from the supply conduit 111 by means of the primary gasket 112 in the fluid isolation configuration, and the float 4 pressurizes the fluid in the pressure chamber 110.

In an embodiment, when the fluid in the supply conduit 111 exceeds the pressure of the fluid in the pressure chamber 110, the primary gasket switches to the fluid communication configuration, allowing the pressure in the pressure chamber 110 to be increased.

In an embodiment, the primary gasket 112 is axially movable in the primary gasket seat 105 between a fluid isolation configuration, in which the primary gasket 112 forms a seal with the axial seat wall 107 and the first radial seat wall 108 and with the float 4, and a fluid communication configuration, in which the primary gasket 112 is spaced apart from the axial wall wall 112, abuts against the second radial seat wall 112 allowing the fluid to pass, and forming a seal with the float 4.

The present invention also relates to a braking system for vehicles, comprising at least one electro-hydraulic actuator 100 according to any one of the previously described embodiments, where said at least one hydraulic actuator 100 is in hydraulic connection with at least one braking device, such as a brake caliper.

### LIST OF REFERENCE SIGNS

1 electric motor
2 drive shaft
3 transformation mechanism
4 float
5 first housing
6 second housing
7 reduction unit
8 output shaft
9 bearing
10 transformation unit
11 rotating member
12 translatable thrust member
13 fixed bearing portion
14 rotating bearing portion
15 first shoulder of first housing
16 reduction gear
17 reduction gear coupling portion
18 reduction gear abutment portion
19 threaded portion
20 threaded counter-portion
21 radially outer reduction gear wall
22 first radial wall of first housing
23 crown wheel
24 central crown wheel portion
25 interlocking portion
26 radially outer bearing wall
27 flared portion
28 contact portion
29 connection seat for a tool
30 planetary gear wheels
31 central pinion
32 planet gear pin or pivot
33 plastically deformed portions
34 shank portion
35 shank side surface
36 connection hole surface
37 rotating body
38 annular depression
39 annular ridge
40 bearing abutment surface
41 balls
42 thrust cap
43 cap cavity
44 cap side wall
45 cap bottom wall
46 free end
47 central free end surface
48 inner cap side surface
49 inner bottom cap surface
50 outer bottom cap surface
51 central float surface
52 hydraulic cap
53 axial opening of first housing
54 elastic element
55 first hollow float portion
56 radial float wall
57 through radial opening
58 axial float wall
59 hydraulic cap gasket
60 hydraulic cap side wall
61 cap coupling portion
62 thrust member coupling counter-portion
63 anti-rotation sleeve or device
64 transformation unit seat
65 reduction unit seat
66 bearing seat
67 second radial wall of first housing
68 third radial wall of first housing
69 second shoulder of first housing
70 third shoulder 44 first housing
71 anti-rotation side wall
72 straight anti-rotation surfaces
73 straight thrust member surfaces
74 curvilinear anti-rotation surfaces
75 curvilinear thrust member surfaces
76 fixing flange
77 anti-rotation fixing screws
78 axial ribbings
79 float coupling seat
100 Electro-hydraulic actuator
103 cylinder wall
104 float seat
105 primary gasket seat
106 secondary gasket seat
107 axial seat wall
108 first radial seat wall
109 second radial wall
110 pressure chamber
111 supply conduit
112 primary gasket
113 secondary gasket
L1 axial coupling length
L2 axial central portion length
X-X axial direction
R-R radial direction
A central axis

1-11. (canceled)

12. An electro-hydraulic actuator (100) for actuating a brake caliper, in particular of a disc brake of a vehicle with two or more wheels, comprising:
an electric motor (1) with a drive shaft (2);
a transformation mechanism (3) connected to the drive shaft (2) to transform a rotary motion of the drive shaft (2) into a linear translatory motion along an axial direction (X-X) of a float (4) of a hydraulic pump or brake master cylinder of said brake to pressurize a brake fluid;
a first housing (5) configured to accommodate the transformation mechanism (3) and support a second housing (6) of the electric motor (1), said transformation mechanism (3) including:
a reduction unit (7) with at least one output interface (8) and configured to demultiply the rotary motion of the drive shaft (2) and transmit it to at least one output interface (8),
a transformation unit (10) to convert the rotary motion of the at least one output interface (8) into a translatory motion of the float (4), the transformation unit (10) comprising a rotating member (11), which is connected to the at least one output interface (8), and a thrust member (12), which is linearly translatable, wherein the rotating member (11) is mechanically coupled to the thrust member (12) so to transform a rotation of the rotating member (11) into a linear translation of the thrust member (12) which allows a displacement in the axial direction (X-X) of the float (4),
a bearing (9) connected to both the rotating member (11) and the first housing (5) to allow the rotation of the rotating member (11) with respect to the first housing (5), characterized in that
the bearing (9) is packed between a first-housing shoulder (15) and said reduction unit (7) by constraining the bearing (9) in first housing (5), so that a constraining reaction of the transformation unit (10) due to the action of the float (4) on the brake fluid is discharged directly onto the reduction unit (7).

13. An electro-hydraulic actuator (100) according to claim 12, wherein said reduction unit (7) comprises at least one rotationally locked reduction gear (16), which comprises
a reduction gear coupling portion (17) to form an integral connection with the first housing (5) of the transformation mechanism (3) configured to constrain the at least one reduction gear (16) inside the first housing (5),
an abutment portion (18) adapted to abut against and/or adapted to abuttingly receive the bearing (9) forming an axial constraint for the bearing (9),
wherein the bearing (9) is tightened between the abutment portion (18) and the first-housing shoulder (15), either with or without clearance, so that the constraining reaction of the transformation unit (10) due to the action of the float (4) on the brake fluid is discharged directly onto the abutment portion (18) and indirectly on the first housing (5).

14. An electro-hydraulic actuator (100) according to claim 13, comprising at least one of the following features or a combination thereof:
wherein said reduction gear coupling portion (17) comprises at least one threaded portion (19) made on a radially outer reduction gear wall (21) of the reduction gear (16) adapted to connect to a threaded counter-portion (20) made on a first radial wall (22) of said first housing (5), so as to constrain the reduction gear (16) in the first housing (5) up to abut the reduction gear abutment portion (18) against the bearing (9),
and/or wherein the reduction gear abutment portion (18) is an annular surface which axially delimits the reduction gear (16).

15. An electro-hydraulic actuator (100) according to claim 12, comprising at least one of the following features or a combination thereof:
wherein said reduction unit (7) comprises a reduction gear (16), said reduction gear (16) comprising a crown wheel (23) with internal one-piece toothing and rotationally locked to the first housing (5), and/or
wherein the transformation unit (10) is a screw-nut assembly, preferably with recirculating ball.

16. An electro-hydraulic actuator (100) according to claim 15, comprising at least one of the following features or a combination thereof:
wherein the electric motor (1) and the transformation mechanism (3) are arranged in cascade along said axial direction (X-X),
and/or wherein
the bearing (9) comprises a fixed bearing portion (13) rotationally locked to the first housing (5) and a rotating bearing portion (14) rotatable with respect to the fixed bearing portion (13), wherein the rotating bearing portion (14) is connected to the at least one output interface (8) to rotate integrally with the at least one output interface (8),
wherein the rotating member (11) is connected to the rotating bearing portion (14) so as to rotate integrally with the rotating bearing portion (14),
wherein the bearing (9) is axially constrained inside the first housing (5) with the fixed bearing portion (13) abutting on one side against the first-housing shoulder (15) and on the other side against a reduction gear abutment portion (18) of the reduction unit (7), and/or wherein said crown wheel (23) with internal toothing comprises
a reduction gear coupling portion (17) to form an integral connection with the first housing (5) thus axially locking the crown wheel (23) inside the first housing (5), and
a reduction gear abutment portion (18) adapted to abut against the fixed bearing portion (13) thus axially locking the bearing (9) inside the first housing (5) so that the axial reaction of the transformation unit (10) due to the action of the float (4) on the brake fluid is discharged onto the reduction gear abutment portion (18) of said crown wheel (23).

17. An electro-hydraulic actuator (100) according to claim 16,
wherein said crown wheel (23) comprises an interlocking portion (25) adapted to face with a radially outer bearing wall (26) of the fixed bearing portion (13) to center and/or radially tighten the fixed bearing portion (13),
wherein the reduction gear abutment portion (18) forms a shoulder for the interlocking portion (25), wherein the interlocking portion (25) projects axially from the reduction gear abutment portion (18) in a cantilevered manner.

18. An electro-hydraulic actuator (100) according to claim 17, comprising at least one of the following features or a combination thereof:
wherein said interlocking portion (25) comprises a flared portion (27) adapted to accommodate and forming a taper for a centered insertion of the fixed bearing portion (13) into the interlocking portion (25),
wherein said interlocking portion (25) comprises a contact portion (28) adapted to interfere and/or face with the radially outer bearing wall (26) of the fixed bearing portion (13) to tighten and/or center radially the fixed bearing portion (13),
and/or wherein said crown wheel (23) comprises a central crown wheel portion (24) which has an internal toothing, wherein the reduction gear coupling portion (17) extends axially over an axial coupling length (L1) being greater than an axial central portion length (L2) along which the central crown wheel portion (24) axially extends, and/or wherein the crown (23) comprises at least one connection seat (29), such as a blind hole made on a surface axially opposite to the reduction gear abutment portion (18), adapted to receive a tool to connect the crown wheel (23) to the first housing (5).

19. An electro-hydraulic actuator (100) according to claim 15, comprising at least one of the following features or a combination thereof:
wherein said reduction unit (7) comprises an epicyclic reduction gear or a harmonic reduction gear,
and/or wherein said reduction unit (7) comprises at least a first reduction portion, which includes at least a first reduction stage, operatively associated with said crown wheel (23) with internal toothing,
and/or wherein said reduction unit (7) comprises at least one planetary gear wheel train (30), and a central pinion (31) integral with and/or formed by the end of the drive shaft (2) and having an external toothing, wherein the planetary gear wheels (9) of the at least one planetary gear wheel train (9) mesh with both the central pinion (31) and the crown wheel (23).

20. An electro-hydraulic actuator (100) according to claim 19, wherein each planetary gear wheel (9) rotates about a planet gear pin or pivot (32), wherein each planet gear pin (32) is constrained to the rotating bearing portion (14), wherein said at least one output interface (8) comprises each planet gear pin (32);
and/or wherein each planet gear pin (32) rotates on the same circumference about the axial direction (X-X).

21. An electro-hydraulic actuator (100) according to claim 12,
wherein the first housing (5) houses in cascade along the axial direction (X-X), wherein the axial direction (X-X) is straight: the reduction unit (7), the bearing (9), the transformation unit (10), and the float (4),
wherein the first housing (5) comprises a cylinder wall (103) which internally delimits a float seat (104) adapted to house the float (4) in a sliding and fluid-tight manner, wherein the cylinder wall (103) delimits a pressure chamber (110) fluidly connectable to a braking device, wherein the cylinder wall (103) delimits a primary gasket seat (105) and a secondary gasket seat (106),
wherein the first housing (5) defines a supply conduit (111) fluidly connectable to a tank and/or fluid feeding valve, wherein said supply conduit (111) leads into a supply opening (112) on said cylinder wall (103) between said primary gasket seat (105) and said secondary gasket seat (106),
wherein the first housing (5) delimits, at one end thereof downstream of said float (4), an axial first-housing opening (53) on the side axially opposite to said electric motor (1),
wherein the electro-hydraulic actuator (100) comprises a hydraulic cap (52) fluid-tightly connected to said first housing (5) to close the axial first-housing opening (53), wherein the hydraulic cap (53) is made in a separate piece from said first housing (5).

22. A braking system for vehicles, comprising at least one electro-hydraulic actuator (100) according to claim 12, wherein said at least one hydraulic actuator (100) is in hydraulic connection with at least one braking device, such as a brake caliper.
